(19) United States
(12) Patent Application Publication
(10) Pub. No.: US 2022/0081791 A1
(43) Pub. Date: Mar. 17, 2022

(54) ELECTROCHEMICAL GAS PRODUCTION CELL, IN PARTICULAR A MERCURY-FREE HYDROGEN PRODUCTION CELL

(71) Applicant: SIMATEC AG, WANGEN AN DER AARE (CH)

(72) Inventors: HANS GFELLER, AARWANGEN (CH); PASCAL HAERING, MUTTENZ (CH); MARCO GERBER, BASEL (CH); BEAT STEIGER, TECKNAU (CH)

(21) Appl. No.: 17/422,836

(22) PCT Filed: Dec. 17, 2019
(86) PCT No.: PCT/EP2019/085689

§ 371 Date: Jul. 14, 2021

(30) Foreign Application Priority Data
Jan. 15, 2019 (EP) 19151868.7

(51) Int. Cl. C25B 11/091; C25B 1/02; C25B 11/032; C25B 11/065

(52) U.S. Cl. CPC C25B 11/091; C25B 11/065; C25B 11/032; C25B 1/02

(57) ABSTRACT

An electrochemical, in particular mercury-free hydrogen production cell, is free of Raney nickel and corresponds to electrochemical gas production cells using Raney nickel regarding blank gassing rate and other electrochemical characteristics. The cell includes a metal anode, electrolyte and gas diffusion electrode. The gas diffusion electrode has, as a metal-containing main component, steel alloy and/or catalytic inorganic metal compound and/or platinum or palladium powder, all free of Raney nickel. Avoiding Raney nickel provides increased industrial safety. The substitute materials have significantly fewer risks regarding transportation, fire hazard and toxicology. Necessary preventative measures therefore require substantially less outlay. The amount of nickel (if nickel-containing compound is used) is at least 2 factors lower or tends towards zero. The substitute materials exhibit good to very good electrochemical activity and provide hydrogen production cell efficiency and stability as adequate as cells with a cathode containing Raney nickel.

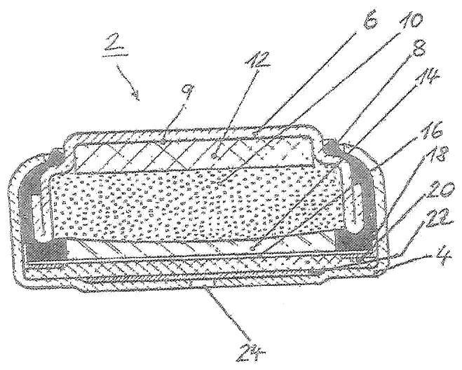

The present invention relates to an electrochemical gas production cell, in particular to a mercury-free hydrogen production cell.

As a rule gas production cells are used to build up a pressure by means of gas production and, in this way, to move/convey fluid media automatically. Lubricants, fragrances, and medicines can be quoted as examples of fluid media. Generic gas production cells are known for example from the unexamined German application 35 32 335 and the European patent application EP 1 396 899 A2.

As a rule modern gas production cells operate as hydrogen production cells. In such cells, in an electrochemical reaction at the anode, metallic zinc is oxidized in an alkaline electrolyte to form twice positively charged zinc ions (Zn²⁺) and the desired hydrogen gas is produced at the cathode from water by a reduction reaction. These electrochemical gas production cells have often been constructed with zinc powder containing mercury. The mercury in this case serves as corrosion protection for a current collector on the battery side providing negative metallic zinc (anode side during discharging) and likewise contributes to a reduction of undesired hydrogen production through self-corrosion of the zinc, in which otherwise an undesired spontaneous production of hydrogen on the zinc-containing anode would arise through an alkaline zinc corrosion or through a formation of an electrochemical local element with the surface of the current collector. The mercury content in existing gas cells of type Zn/alkaline electrolyte/carbon-nickel relative to the overall metal content in the zinc powder amounts to around 1 to 8%. As well as this mercury content, these types of gas production cells can also contain smaller elements of lead and cadmium. These admixtures likewise typically lie in the range of 0.5 to 6%.

Because of the toxicity of the metals mercury, lead and cadmium, as part of strict legal requirements, there has been work on substitution of these substances by less toxic metals or non-metallic additives, or the use of less toxic metals while simultaneously banning mercury, lead and cadmium has been made a mandatory requirement. Traces of Hg, Cd and Pb can still occur however. At this point therefore, when Hg, Cd and Pb additives are dispensed with, it should be pointed out that it is not necessary to declare these metals according to the EU battery directive. Article 21(3) of the EU battery directive 2006/66/E, with the annexes from 2013/56/EU states that, according to this directive, the cell can be said to be free from mercury, cadmium and lead when the corresponding content of Hg amounts to less than 5 ppm Hg, for Cd to less than 20 ppm and for Pb to less than 40 ppm, relative to the overall weight of the product. A solution in this regard according to these regulations has been disclosed by European patent application EP 2 337 124 A1.

With the additives indium and bismuth the zinc self-discharging in alkaline electrolytes can be successfully suppressed and in this way a controlled and long-term linear oxidization of the zinc and thus the desired stability of the hydrogen production set. These additives avoid the use of mercury, cadmium and lead so that, according to the aforementioned EU regulation, they can be said to be free of mercury, cadmium and lead, because the limit values prescribed in the EU regulations for these metals are not exceeded and the gas production cell constructed in this way is thus no longer notifiable.

In purely technical terms traces of these metals can naturally still be present and even desired, but the proportion of these metals, as a result of the additives, can now be kept well below the specified limit values.

These types of electrochemical hydrogen production cells are further constructed these days with an addition of typically 20% to 30% of Raney nickel as the electrochemical catalyst in the positive electrode (cathode during discharging). In order to suppress the pyrophoric characteristics of the Raney nickel, this is typically passivated with oxygen and water vapor at increased temperature. This process, as well as the following processes, which use Raney nickel or its oxides, oxi-hydroxides or hydroxides, must be carried out using the appropriate protective measures for handling and processing. The risks, as well as spontaneous combustion, are significant risks to health if people come into contact with Raney nickel. The corresponding regulations for safe processing differ somewhat from country to country, but always refer to the same dangers.

The underlying object of the present invention is therefore to specify an electrochemical cell, and in particular a mercury-free hydrogen production cell, which is free from Raney nickel and in respect of a blank gassing rate and the other electrochemical characteristics can correspond to the electrochemical gas production cells that have previously been realized with the use of Raney nickel.

The object is achieved in accordance with the invention by an electrochemical gas production cell, in particular a mercury-free hydrogen production cell, which has a metal anode, an electrolyte and a gas diffusion electrode, wherein the gas diffusion electrode, as its metal-containing main component, has a steel alloy and/or catalytic inorganic metal compound and/or platinum or palladium powder, with all the aforementioned materials being free of Raney nickel.

Avoiding Raney nickel provides increased industrial safety. The identified substitute materials have significantly fewer risks with regard to transportation, fire hazard and toxicology. The necessary preventive measures accordingly require substantially less outlay. The amount of nickel used (in the event that a nickel-containing compound is used) is lower by at least a factor of two or tends towards zero. The identified substitute materials exhibit good to very good electrochemical activity and result in hydrogen production cells, which in relation to the efficiency of their hydrogen production and their stability, are similar to the cells that are equipped with a cathode containing Raney nickel.

In an advantageous embodiment of the invention the metal-containing main component of the gas diffusion electrode can be applied as a composite to a carrier material, preferably carbon, a silicon compound or a polymer, such as e.g. PTFE. In this way characteristics (porosity, wetting, activity, mechanical stability etc.) of the gas diffusion electrode can be set as required within comparatively wide limits.

As a substitute for Raney nickel it has been shown that the metal-containing main component of the gas diffusion electrode can comprise one of more of the following substances:

a) A nickel-iron alloy;
b) A chrome-nickel alloy (Cr—Ni steel can contain: Chrome/nickel/iron/Mo, V, W etc.);
c) A nickel-iron-sulfur compound, e.g. Pentlandite;
d) A nickel-copper alloy;
e) A tungsten bronze, in particular tungsten-sodium bronze
f) A tungsten-carbon compound, in particular tungsten carbide;
g) A tungsten-selenium compound, in particular tungsten-diselenide; and/or
h) Mixed metal oxides, which contain oxides of one or more of the metals Ni, Fe, Zn, Mg, Cr and Cu, preferably iron-oxide, such as magnetite (iron(II/III)-oxide), zinc-iron oxides such as for example ZnFe₃O₄, and Mg-iron oxides.

In order, even in the case of a composite, to be able to provide an adequate catalytic activity, it is preferentially advantageous if a composite with carbon with an allocation of 500 ppm to 20000 ppm of the metal-containing main component of the gas diffusion electrode is present.

Preferred exemplary embodiments of the present invention are explained in greater detail below with the aid of a drawing. In this drawing the FIGURE shows a schematic view of the structure of an inventive gas production cell 2. The gas production cell 2 comprises a dish 4 and a cover 6 that, together with a seal, form the housing of the gas production cell 2. The base of the cover 6 bears an additional coating 9 on its inner side made of a Cu/Zn alloy, with which the hydrogen overvoltage of the surface of the electroactive material can be increased, the corrosion properties of a zinc anode 10 improved and the contact resistance between the zinc anode 10 and the cover base, which serves as a current collector, can be stabilized. This coating 9 can also consist of a Cu/Sn or a Cu/Zn/Sn alloy or any combination of the alloys mentioned here.

In the present example the zinc anode 10 consists of zinc powder with additives of indium and bismuth. The concentration of indium and bismuth in each case amounts to around 300 ppm. This concentration can however lie in the range of around 50 to 2000 ppm overall. The grain sizes of the indium and bismuth admixtures correspond to the grain sizes of the zinc powder, which lie in the range of 1 to 500 μm. These grain sizes can however lie in the range of 0.5 to 1000 μm. The zinc anode 10 formed in this way is free of additives that contain mercury, lead or cadmium. These elements can still be present however as trace contaminants, but do not exceed the values of 0.0005% Hg, 0.002% Cd and 0.004% Pb calculated on the overall weight of the electrochemical cell. There is therefore no obligation to declare the cell for these elements in accordance with the European battery directive 2000/66/EC. If these concentrations of contaminants are not exceeded, the cell is generally interpreted as being mercury-free, lead-free and cadmium-free. On the base of the cover 6 a porous, compressible element 12 can be arranged, which can provide additional electrolyte solution. Arranged on the side of the zinc anode 10 that faces away from the base of the cover 6 is an electrolyte-soaked fleece 14. The electrolyte itself comprises an around 20 to 40% caustic potash solution. Moreover the electrolyte contains corrosion inhibitors and viscosity promoters as well as optional surface-active substances, which help overall to further improve the system. The choice of this electrolyte with the additives mentioned here supports the reduction of the zinc self-discharging, the spontaneous and uncontrolled production of hydrogen and the potential difference of local elements.

The electrolyte fleece is covered on the cathode side by a separator foil 16. The separator foil 16 is a typical porous polymer membrane, as is also used for example in batteries with alkaline electrolyte. The separator foil 16 is held in position by a support ring 18. The separator foil 16 is adjoined by a gas diffusion electrode 20, which consists of a PTFE-bound, nickel-containing powder layer, which has been rolled into a nickel net and possesses a porous PTFE film towards the dish base side. This foil is not necessary for the function, but serves however for improved sealing with regard to the electrolyte flowing out into the open system on the gas diffusion side. The metallic support ring 18 is in contact with the gas diffusion electrode 20 and connects it electrically to the dish 4. Inserted between the gas diffusion electrode 20 and the base of the dish 4 is a further roughly porous layer of fleece 22, which serves to guide the hydrogen gas emerging from the gas diffusion electrode 20 over the surface during operation to a hole 24 in the dish base and to let its escape there.

For the gas diffusion electrode 20 it is especially significant in the sense of the present invention that the metal-containing main component is free from Raney nickel. In order however to be able to guarantee a comparable catalytic activity and porosity of the gas diffusion electrode, a steel alloy and/or a catalytic inorganic metal compound and/or platinum or palladium powder, all the materials mentioned here being free from Raney nickel, is used as the metal-containing main component.

Individually experimental investigations for the composition of the gas diffusion electrode have been carried out with 0% steel-316L powder, with 28% steel-316L powder and with 53.8% steel-316L steel percent by weight in the active mixture of the gas diffusion electrode. The steel powder used had a particle size distribution between 10 μm and 45 μm. The results show that 0% percent by weight of 316L steel powder leads to a greatly reduced and uneven activity of the electrode.

28% fraction share of 316L steel powder leads to adequate and even activity of the electrode by comparison with an electrode containing 28% Raney nickel, a further increase to 53.8% percent by weight of 316L steel powder does not show any further improvement of the activity.

The trial with 28% percent by weight of significantly finer 316L steel powder has shown that finer powder shows a significantly higher activity. In particular the nano powder of 316L steel (70 nm to 150 nm) is superior to steel powders with particle sizes in the micrometer range as regards activity.

1-5. (canceled)

6. An electrochemical gas production cell or mercury-free hydrogen production cell, comprising:
a metal anode;
an electrolyte; and
a gas diffusion electrode, said gas diffusion electrode having a metal-containing main component including at least one of a steel alloy or a catalytic inorganic metal compound or a platinum or palladium powder all being free of Raney nickel.

7. The electrochemical gas production cell according to claim 6, wherein said metal-containing main component of said gas diffusion electrode is a composite applied to a carrier material.

8. The electrochemical gas production cell according to claim 7, wherein said composite includes carbon, a silicon compound or a polymer.

9. The electrochemical gas production cell according to claim 6, wherein said metal-containing main component of said gas diffusion electrode includes at least one substance selected from:
a) a nickel-iron alloy;
b) a chrome-nickel alloy;
c) a nickel-iron-sulfur compound;
d) a nickel-copper alloy;
e) a tungsten bronze;
f) a tungsten-carbon compound;
g) a tungsten-selenium compound; or
h) mixed metal oxides containing oxides of at least one metal selected from Ni, Fe, Zn, Mg, Cr and Cu, iron oxide, zinc-iron oxide, and Mg-iron oxides.

10. The electrochemical gas production cell according to claim 9, wherein:
said nickel-iron-sulfur compound is Pentlandite;
said tungsten bronze is tungsten-sodium bronze;
said tungsten-carbon compound is tungsten carbide;
said tungsten-selenium compound is tungsten diselenide;
said iron oxide is magnetite iron(II/III) oxide; and
said zinc-iron oxide is ZnFe₃O₄.

11. The electrochemical gas production cell according to claim 8, wherein said composite is present as an allocation of 500 ppm to 20000 ppm of said metal-containing main component of said gas diffusion electrode.

12. The electrochemical gas production cell according to claim 11, wherein said composite includes carbon.

13. The electrochemical gas production cell according to claim 6, which further comprises at least one of metal powder or powder from metal alloys with particle sizes of 50 nm to 100 μm.

14. The electrochemical gas production cell according to claim 6, which further comprises at least one of metal powder or powder from metal alloys with particle sizes of 10 nm to 1 μm.
